(19) United States
(12) Patent Application Publication
(10) Pub. No.: US 2020/0114317 A1
(43) Pub. Date: Apr. 16, 2020

(54) SUPPORT LAYERS FOR FORWARD OSMOSIS MEMBRANES

(71) Applicant: Oasys Water LLC, Dover, DE (US)

(72) Inventors: John Charest, Somerset, MA (US); Diego Amado-Torres, Malden, MA (US)

(21) Appl. No.: 16/711,453

(22) Filed: Dec. 12, 2019

Related U.S. Application Data
(63) Continuation of application No. PCT/US2016/063463, filed on Nov. 23, 2016.
(60) Provisional application No. 62/259,601, filed on Nov. 24, 2015.
(60) Provisional application No. 62/259,603, filed on Nov. 24, 2015.
(60) Provisional application No. 62/300,219, filed on Feb. 26, 2016.
(60) Provisional application No. 62/384,549, filed on Sep. 7, 2016.

(51) Int. Cl. B01D 69/10; B01D 61/00; B01D 71/56; B01D 71/80; C02F 1/44

(52) U.S. Cl. CPC B01D 69/105; B01D 61/002; C02F 1/445; B01D 71/80; B01D 71/56

(57) ABSTRACT

The invention relates generally to forward osmosis membranes and methods of making forward osmosis membranes, in particular improved thin support layer upon which an active layer is cast.

### CROSS-REFERENCE TO RELATED APPLICATION

This application is a continuation of International Application No. PCT/US2016/063463 filed on Nov. 23, 2016, which claims priority to and the benefits of U.S. Provisional Application Nos. 62/259,603 filed on Nov. 24, 2015, 62/259,601 filed on Nov. 24, 2015, 62/300,219 filed on Feb. 26, 2016, and 62/384,549 filed on Sep. 7, 2016. All contents of the above applications are incorporated herein by reference.

### FIELD OF THE INVENTION

One or more aspects relate generally to membranes for use in osmotic separation processes. More particularly, one or more aspects involve improvements to membrane support layers to optimize engineered osmotic separation processes.

### BACKGROUND

Semipermeable membranes are substantially permeable to a liquid and substantially impermeable to solutes based on the nature of their selective barrier. Osmotically driven membrane separation generally relies upon driving forces associated with the passage of draw solutes through one or more support layers of a membrane used in the separation process.

Polymeric membranes used in liquid separations are typically thin-film composite (TFC) membranes which generally include a selective barrier on a porous support structure. Recent development of highly selective membranes has been focused primarily on the reverse osmosis (RO) process. Reverse osmosis is a pressure driven process in which the primary resistance to water flux through the membrane is hydrodynamic once the osmotic pressure of the solution is overcome by an excess of hydraulic pressure. Forward osmosis (FO), by contrast, is an entirely osmosis-based process where diffusion is driven by osmosis. The factors affecting water flux in RO and FO processes are different, in turn requiring different membrane structures for optimum performance.

### SUMMARY

In accordance with one or more embodiments, a method of making a forward osmosis (FO) membrane may comprise providing a support structure including at least a first layer and a second layer, applying a material to a first layer of the support structure to form a membrane support layer, applying a barrier material to the membrane support layer to form the forward osmosis membrane, and releasing the forward osmosis membrane by separating the first layer of the support structure from the second layer of the support structure; for example, via peeling, dissolving, or otherwise removing the second, typically heavier layer. In some alternative embodiments, the two-layer support substrate can be replaced with a single layer that has the required thinness and openness for a forward osmosis application while also having the necessary strength and/or thickness to be run through conventional membrane fabrication equipment.

In one aspect, the invention relates to a membrane manufactured with an enhanced support layer. The membrane comprises a support substrate onto which the enhanced support layer is disposed and an active layer is disposed onto the support layer. The support layer is manufactured from a solution comprising a polymer, a nonionic surfactant, and an ionic surfactant. In various embodiments, the polymer is at least one of a polysulfone or a polyethersulfone and is present in the casting solution at about 10 to about 20 wt % of the solution, preferably about 12 to about 16 wt %, and more preferably, about 13 to about 15 wt %. The nonionic surfactant can be present in the casting solution at about 0.1 to about 1.5 wt % of the solution, preferably about 0.2 to about 1.0 wt %, and more preferably about 0.30 to about 0.75 wt %. The ionic surfactant can be present in the casting solution at about 0.05 to about 1.5 wt % of the solution, preferably about 0.1 to about 0.8 wt %, and more preferably about 0.15 to about 0.45 wt %. Examples of ionic and nonionic surfactants are disclosed hereinbelow.

In another aspect, the invention relates to a forward osmosis membrane including a support substrate having a first surface and an opposing second surface, a support layer disposed on the first surface of the support substrate, the support layer including a polymer, an ionic surfactant, and a nonionic surfactant, and a selective layer disposed on the support layer. In various embodiments, the polymer is a polysulfone, a polyethersulfone, or combinations thereof. The nonionic surfactant can include polyoxyethylene (20) cetyl ether or any of the other nonionic surfactants disclosed herein, either alone or in combination. The ionic surfactant can include an organic acid phosphate (e.g., alkyl phosphate ester or amyl acid phosphate, such as are available under the RHODAFAC tradename).

In another aspect, the invention relates to a support layer for a forward osmosis membrane, where the support layer includes a polymer, such as polysulfone, polyethersulfone, or combinations thereof; an ionic surfactant; and a nonionic surfactant. In various embodiments, the support layer can be manufactured in accordance with any of the methods and formulas disclosed herein.

In another aspect, the invention relates to a method of making a support layer for a forward osmosis membrane. The method includes the steps of providing a support substrate having a first surface and an opposing second surface, casting a polymer solution onto the first surface of the substrate, wherein the polymer solution includes a polymer such as polysulfone, polyethersulfone, or combinations thereof, a nonionic surfactant, an ionic surfactant, and a solvent, and introducing the support substrate to a quench bath.

In various embodiments of the method the quench bath includes a solution at a temperature of about 18° C. to about 60° C., with the temperature at 18° C., 45° C., or 60° C. for specific embodiments. In some cases, the quench bath also includes one or more surfactants. The polymer solution may contain the polymer at about 10 to 20 wt % of the solution, preferably at about 12 to 16 wt %, and more preferably at about 13 to 15 wt %. In some embodiments, the ionic surfactant includes an organic acid phosphate such as those disclosed herein and can be present at about 0.05 to 1.5 wt % of the solution, preferably at about 0.1 to 0.8 wt %, and more preferably at about 0.15 to 0.5 wt %. In some embodiments, the nonionic surfactant includes polyoxyethylene (20) cetyl ether or similar compound as disclosed herein and can be present at about 0.1 to 1.5 wt % of the solution, preferably at about 0.2 to 1.0 wt %, and more preferably at about 0.3 to 0.75 wt %. In various embodiments, the polymer solution also includes water.

In some embodiments, the support structure may comprise a bilayer structure. The first layer of the support structure may have a Frazier air permeability of greater than about 50 ft³/ft² min. The material applied to the first layer of the support structure may be applied in a coating of between about 5 and 20 g/m². The forward osmosis membrane may have an overall thickness of less than about 125 microns. The barrier material may comprise a semipermeable material. In at least one embodiment, the barrier material may comprise a polymer. In some embodiments, the barrier material may comprise a polyamide, polyamide urea, polypiperazine, or a block co-polymer. The support structure may comprise a polymeric paper. The support structure may comprise PET, polyethylene, or polypropylene. For example, the substrate may be a non-woven paper made from polyethylene coated polypropylene strands. The support layer may contain less than about 30 g/m² of material overall. The supporting material may be applied in a coating of between about 8 and 20 g/m², preferably between about 10 and 18 g/m². The combined weight of the support layer, support material, and barrier layer overall may be between about 20 and 40 g/m². The support layer may be made in a wet laid process.

In accordance with one or more embodiments, a method of facilitating a forward osmosis separation operation may comprise providing a membrane fabricated in accordance with the methods described herein, configuring the forward osmosis membrane in a forward osmosis membrane module, and introducing a feed solution to one side of the membrane and a draw solution to the other side of the membrane.

Generally, forward osmosis membranes are operated at little to no pressure (e.g., 100 psi or less), which reduces or eliminates the compaction issues associated with operating at the higher pressures that exist in reverse osmosis membrane systems. However, the salt rejection of reverse osmosis membranes severely declines when the pressure is less than 100 psi. This results in very low rejection when trying to use a conventional reverse osmosis membrane in a forward osmosis application. Meanwhile, forward osmosis membranes need to be designed and manufactured in a way that prevents back diffusion of salt from a draw solution to the feed solution. The back and forth salt passage in FO membranes is typically enhanced due to ion exchange and Donnan effects. However, providing an optimized support layer that reduces internal concentration polarization (ICP) and has good wetting can address some of these issues with operating a FO membrane. The alternative support layer chemistries disclosed herein are suitable for improving the operation of the FO membranes by providing high rejection at low pressures and improving overall flux.

In various aspects, the invention relates to FO membranes that include enhanced support layers (i.e., the layer onto which the active layer is cast). These support layers include polysulfone (PS), polyethersulfone (PES), or a blend of these two polymers prepared from PS or PES in a DMF solution with 0.01% to 5.0% of surfactants, with or without other non-solvent additives (e.g., water) and with or without a salt, such as LiCl cast on a non-woven substrate that is then immersed in a coagulation bath and rinsed in water. In various embodiments, the support layer can include other similar polymers. Generally, the support layer is prepared by coating the substrate with the aqueous phase first and then the organic phase as discussed in greater detail below. In additional embodiments, the support layer can be improved by the use of ionic or nonionic surfactants in the coagulation/quench tank or subsequent rinse tanks, with or without the use of sonication.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention and are not intended as a definition of the limits of the invention. For purposes of clarity, not every component may be labeled in every drawing. In the following description, various embodiments of the present invention are described with reference to the following drawings, in which:

FIG. 1 is a SEM image of the cross-section of a membrane made in accordance with one or more embodiments of the invention;

FIG. 2 is a SEM image of a surface of a membrane made in accordance with one or more embodiments of the invention, where the membrane was cast of PS at 18° C. with RHODAFAC and has good surface porosity;

FIG. 3 are SEM images of the cross-section of another membrane made in accordance with one or more embodiments of the invention to have a more open internal structure, where the membrane comprised PES (14%) with BRIJ58 (1%) and 1.5% water cast at 18° C. (left) and 45° C. (right) and the macro voids can be seen with this casting formulation regardless of temperature;

FIG. 4 are SEM images of a surface of another membrane made in accordance with one or more embodiments of the invention that depict the surface of a support layer cast with 14% polymer and 1% PEG 10TDE, where the membrane on the left (100 kX) was casted at 18° C. and the membrane on the right (100 kX) was casted at 45° C. and is much more porous than the same formulation cast in a colder quench tank (left);

FIGS. 5A-5C are SEM images of the surfaces of various membranes made in accordance with alternative embodiments of the invention; and

FIG. 6 are SEM images of membranes, where the left image is a current commercial PS structure that has a dense network and the right image is a membrane cast in accordance with one or more embodiments of the invention.

### DETAILED DESCRIPTION

Osmotic separation processes generally involve generating water flux across a semi-permeable membrane based on osmotic pressure differentials. Solute may be rejected by the membrane and retained on either side due to the greater permeability of water than the solute with respect to the selective barrier of the membrane. Solutes may be undesirable and therefore removed from a process stream via membrane separation for purification, or desirable in which case they may be concentrated and collected via a membrane separation process.

Membranes may be used in various osmotically driven separation processes, such as, but not limited to, desalination, wastewater purification and reuse, FO or PRO bioreactors, concentration or dewatering of various liquid streams, concentration in pharmaceutical and food-grade applications, PRO energy generation and energy generation via an osmotic heat engine.

Polymeric membranes typically include a porous support structure that provides mechanical and structural support for a selective layer. Membranes may be formed in various shapes including spiral wound, hollow fiber, tubular and flat sheet depending on an intended application. Membrane characteristics should be customized to achieve ideal performance and may vary between specific applications. For example, in FO and PRO applications, the effectiveness of a separation process may be enhanced by reducing the thickness and tortuosity of the membrane, while increasing its porosity and hydrophilicity, without sacrificing strength, salt rejection and water permeability properties.

The RO membrane industry has, to date, standardized on a polyethylene terephthalate (PET) support layer with a polysulfone active coating. The PET support layer is generally about four mils thick with a basis weight of approximately 80 g/m² and a Frazier air permeability of approximately four ft³/ft²/min. Although robust, the PET material generally represents the most expensive raw material of the membrane and provides little to no benefit to the performance of the RO membrane. When PET is used as a support structure in other osmotic separation membranes, such as for FO and pressure retarded osmosis (PRO) processes, membrane performance is significantly impeded. Thus, reducing the thickness of the support structure may be desirable. Attempting to reduce the thickness or weight of the support material typically results in membrane processing problems, such as creasing or wrinkling or even web breakage. Thinner support structures may be associated with reduced cost, enhanced mass transfer and higher flux within the membrane by reducing resistance to fluid flow and solute diffusion through the membrane support, and an increase in the amount of active membrane area which may be provided in a separation module.

In accordance with one or more embodiments, a bilayer substrate may be provided to facilitate membrane fabrication. A bilayer substrate may include a membrane support layer which will serve as the membrane support layer of a final membrane product. The membrane support layer of the bilayer substrate may be of reduced thickness compared to conventional membrane support layers while at the same time providing an overall thickness requisite for membrane manufacturing, including the application and processing of a selective layer upon the support layer. In some embodiments, the bilayer support may include a removable backing layer in addition to the membrane support layer to provide the extra thickness. The removable backing layer may be intended to be separated from the support layer subsequent to membrane fabrication. In other embodiments, the bilayer substrate may include a backing layer intended to remain intact subsequent to membrane fabrication.

The membrane support layer may be the support layer of a resultant membrane while the removable backing layer may be largely sacrificial, temporarily providing increased thickness to the support layer to facilitate membrane processing. The membrane support layer of the bilayer substrate may generally be a light basis weight layer of reduced thickness in comparison to a conventional membrane support layer. In at least one embodiment, the support layer may be PET. In some embodiments, the support layer and backing layer may be made of the same material. In other embodiments, they may be made of different materials. The bilayer substrate may be characterized by properties which allow the two layers together to perform similar to an existing standard PET support layer with respect to strength, resistance to creasing, and general processing in the membrane manufacturing process.

In some embodiments, the backing layer may typically be about two to about four mils in thickness with a Frazier air permeability of less than about 6 ft³/ft²/min. The top layer, which may ultimately be the membrane support structure as described herein, may typically be less than about 2 mils in thickness with a Frazier air permeability of greater than about 100 ft³/ft²/min. The forward osmosis membrane may have an overall thickness of less than about 125 microns. The support layer may contain less than about 30 g/m² of material overall. The supporting material may be applied in a coating of between about 8 and 17.5 g/m². The combined weight of the support layer, support material, and barrier layer overall may be between about 20 and 40 g/m². The top support layer may be made in a wet laid process, dry laid process, or a woven material. Alternatively, the support layer may be made by deposition in the presence of an electrical field, such as in an electrospinning method. Materials may include PET or other polymers typically used in the fabrication of pressure driven membrane supports, and may additionally be designed to have a hydrophilic nature. In some embodiments, the support structure may be a paper, such as a polymeric paper. In some embodiments, the support material may be made of PET, polypropylene, PS, polyacrylonitrile, or other porous polymers suitable for creating a support for interfacial polymerization of a polyamide, polyamide urea, or similar type barrier layer. Hydrophilic additives may be introduced to the support material. Examples of membrane support layers that may be used in conjunction with or in place of the bilayer substrate are described in greater detail below. These layers can be formed with or without certain additives to enhance or otherwise optimize the various structural parameters of the support layer, for example, porosity, tortuosity, thickness, smoothness (e.g., an optimal surface condition for receiving the thin film active/selective layer).

A selective or otherwise active layer may be applied to the support material of the substrate during a membrane manufacturing process. In some embodiments, a semipermeable layer may be applied as the active layer. The semipermeable layer may comprise a polymer, such as a polyamide, a polyamide urea, a block co-polymer, polypiperazine, and/or a random co-polymer. In some embodiments, a PS layer may be applied to a PET support layer of a bilayer substrate. Multi-layered substrates in accordance with one or more embodiments may be easier to coat than single layer since the substrate is sturdier and thicker and thereby less subject to wrinkling and tearing. Subsequent to membrane processing, the backing layer may then be separated and removed. By using the bilayer substrate, a membrane with a support layer of reduced thickness may be produced using standard manufacturing equipment and techniques. In some embodiments, the separation step may be performed prior to application of an active layer.

In accordance with one or more further embodiments, rather than using a bilayer substrate which includes a sacrificial or otherwise removable backing layer, a bilayer substrate may be implemented which is intended to wholly become part of a resultant membrane. In these embodiments, a support polymer may be casted directly onto one or both sides of a tricot-type mesh support material. A polyurethane or other adhesive may be used to bind the support layer to the mesh layer. The support polymer may be PET in certain embodiments. The mesh support, such as a supporting tricot, may conduct fluid flow within a finished membrane module. A membrane barrier layer may then be applied on one or both of these support polymer coatings, forming a final single or double layer membrane with a water conducting mesh as its base or core.

In accordance with one or more embodiments, a bilayer substrate may be pre-wetted to improve mass transfer characteristics of the support polymer and polymer/fabric interface. A solvent such as NMP, DMF, DMSO, triethyl phosphate, dimethyl acetamide, or a combination thereof may be used to prewet. Prewetting may create a more open pore structure, cause less occlusion of pores in the polymer support, enhance polymer porosity by encouraging macrovoid formation, improve pore structure and decrease tortuosity. These properties may be realized and even enhanced by separation of the removable backing layer if used. These properties may be particularly desirable when using bilayer assemblies which are not intended to be separated, such as with supporting tricot mesh and PET fabric, for example, by preventing excessive penetration of the polymer into the supporting material.

In accordance with one or more embodiments, a process to manufacture a membrane for osmotically driven membrane processes may include the use of a drive system to transport a bilayer sheet of support material or other substrate through a casting machine which may deposit a polymer in a solvent solution. Tensions may generally be maintained so as to reduce the possibility of creasing and wrinkling. The bilayer support material may be composed of two layers pressed together such that the bottom layer may be either subsequently removed or ultimately used as a membrane fluid channel spacer mesh.

The bilayer support material or other substrate may be conveyed to a polymer application device which applies a solution of polymer, for example PS, in a solvent, for example DMF. Upon coating, the bilayer material may enter a quenching bath in which the polymer precipitates into the substrate. The temperature of the quenching bath may vary and may impact one or more properties of a resultant membrane. In at least some embodiments, improved properties of forward osmosis membranes may be associated with a quenching bath temperature in the range of about 50° F. to 120° F., preferably about 60° F. to 113° F., and more preferably about 100° F. to 110° F. When using a bilayer substrate, the top layer is designed to allow sufficient penetration of the solution to result in delamination pressures at which the precipitated polymer layer would disengage from the bilayer support material in excess of about ten psig. The backing layer of the bilayer material in contrast is designed to prevent polymer penetration to allow for the two support material layers to be separated after membrane manufacturing. The primary purpose of the backing layer is to prevent creasing and wrinkling of the top layer while processing by providing necessary strength to allow existing membrane machines to convey the very thin membrane required for forward osmosis membranes. The remainder of the membrane production is completed using standard rinsing and membrane casting equipment.

In accordance with alternative embodiments, the creation of the porous support layer onto the substrate can be enhanced by modifying the quench tank composition. Generally, the phase inversion process for the production of the PES or PS or a like-polymer support layer can be improved to yield a support layer that is structurally more ideal for forward osmosis. In one example, the membrane/casting solution is 14.5% polysulfone in DMF with 0.15% RHODAFAC (a surfactant consisting of an aliphatic chain attached to a polyethylene glycol (PEG) chain attached to a phosphate group), and water (e.g., to hydrate/stabilize ionic end of the RHODAFAC) with is cast into an 18° C. quench tank. The support layer resulting from this support layer has a network structure that is approximately 400 nm thick, which is thick enough to decrease the osmotic potential across the membrane. The limitation in the prior art is that the PS or PES structure is not open enough to minimize internal concentration polarization and maximize flux, which leads to making membrane support layers with PS/PES and nonionic surfactants. However, in some cases (e.g., using PES), problems can be encountered in optimizing the process because of the difficulty of extracting the nonionic surfactants from the membrane and granule formation on the surface thereof.

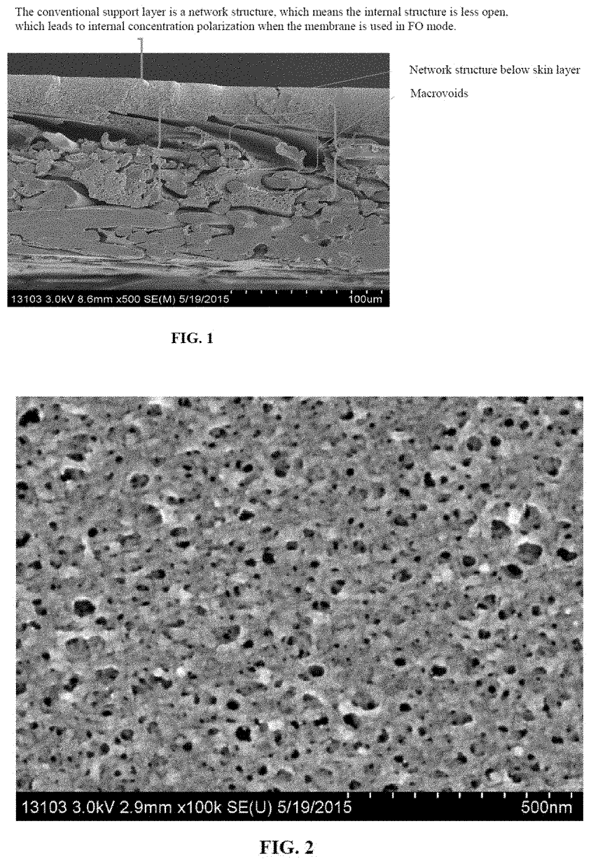

Conventional phase inversion processes done with ionic surfactants, such as RHODAFAC, have been shown to produce substrates with a porous surface and a thick network structure in the middle of the support layer, which increases ICP (see FIG. 1 and FIG. 2). Generally, phase inversion processes done with ionic surfactants, such as RHODAFAC, have been shown to produce substrates with a porous surface and a thick network structure in the middle of the support layer, which increases ICP.

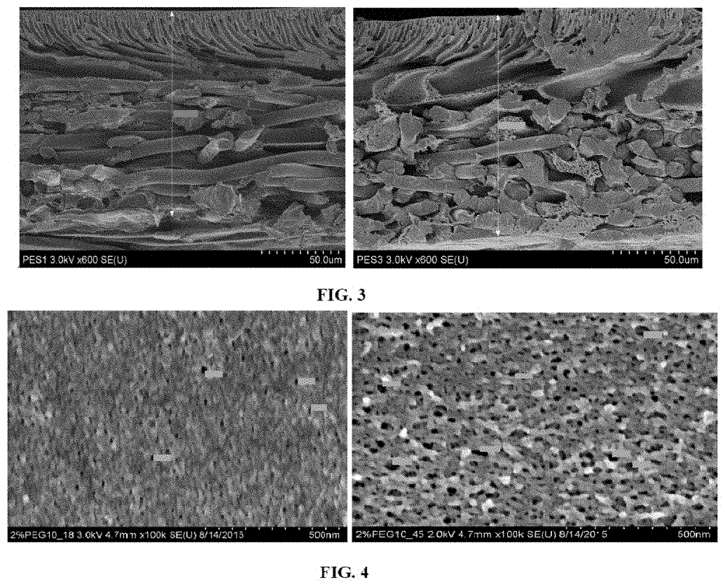

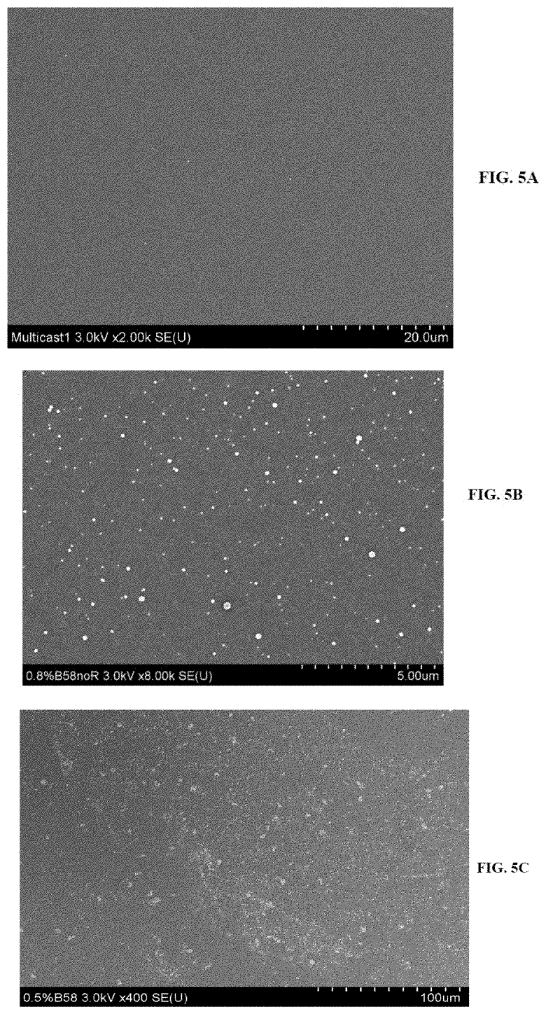

In one aspect, the invention is related to manufacturing processes that will allow for control over support layer morphology (e.g., control of the pores at the surface and the morphology below the surface). In various embodiments, the casting solution will include anywhere from about 8-25%, preferably about 14-16% polymer (e.g., PS or PES), a range of about 0.1-3% of a nonionic surfactant (e.g., polyethylene oxide chain attached to a hydrocarbon chain), and optionally an ionic surfactant and water. During the manufacturing process, this casting solution will be applied to a substrate or web (e.g., polyester or polypropylene) and then the web is passed through a quench tank bath and through from 1 to 4 subsequent rinse tanks. This has been demonstrated and yielded the results shown in FIGS. 3 and 4. Generally, for forward osmosis membranes, it is desirable to have an internal structure of a membrane with the macrovoidal features as shown in FIG. 3. Macro voids have been shown to reduce ICP in forward osmosis membranes by decreasing the tortuosity and opening up the interior of the membrane so a viscous draw solution can easily move closer to the active layer.

In various embodiments, the invention is directed to putting ionic surfactants in the quench tank and/or subsequent rinse tanks in which the web is submerged during the phase inversion process. If the surfactant is used in the quench tank, its purpose would be to change the structure of the membrane formed. If the surfactant was added only to the rinse tanks, the major role of the surfactant would be to remove any nonionic surfactant present in or on the membrane. In some embodiments, to prevent contaminating the support layer with an excess of surfactant, the process can include a water shower before the last rinsing tank.

Examples of ionic surfactants that may be used in the process include: sodium lauryl sulfate (or any sulfate attached to a hydrophobic group), cetrimonium bromide (or any trimethyl ammonium attached to a hydrophobic group), a carboxylate group attached to any hydrophobic group, or any phosphate attached to a hydrophobic group. The hydrophobic chain could be connected to the ionic functional group by a polyethylene chain. In a particular embodiment, the ionic surfactant includes RHODAFAC, which has a PEG chain between an alkyl tail, and a phosphate group end.

In the quench bath of the support layer casting line, the DMF in the casting formulation is exchanged with water. Since the polymer (PS or PES) does not mix with water when the two meet at an interface, the interface of the polymer and DMF are in a high energy state. Because the polymer is in a high energy state, upon contact with water the polymer will recoil from the water molecules. The polymer's contorting of its chain pushes the polymer to be farther from the water and closer to itself. This will force the polymer to eventually collapse on itself and other entangled polymer chains, solidifying from the water/DMF solution into a porous film.

While the polymers recoil from the water interface, surfactants in solution move to align at the interface (with the non-polar sub-unit near the PS/PES and the polar charged group towards the water/DMF). Surfactants, or molecules with hydrophilic and hydrophobic parts, act to stabilize polar and nonpolar interfaces, putting the interface at lower energy levels. The lower the interfacial energy, the slower the polymer's solidification demixing into a porous film. A slower rate of demixing or solidification has been found to increase the network structure in the membrane, while faster demixing leads to macrovoids. It has generally been shown that instantaneous demixing typically results in a highly porous substructure (e.g., with macrovoids) with a thin, finely porous skin layer, and delayed demixing typically results in a porous, often closed-cell and macrovoid-free substructure with a dense, relatively thick skin layer. The availability or concentrations as well as the structure, of the surfactant(s) at the interface are major factors in determining the interfacial tension and the speed of demixing, hence the structure of the support layer.

Linear small and ionic surfactants are more effective at mitigating interfacial tension than large nonionic surfactants. A small ionic surfactant is quicker to twist to align at the interface (with the non-polar sub-unit near the PES and the polar charged group towards the water). Their small size makes the energy to rotate the whole surfactant molecule less than a large surfactant, like a BRIJ. It is much harder for a large nonionic surfactant (like the BRIJ surfactants) to rotate their polymer backbone, especially since the polyethylene oxide chains are not extremely hydrophilic, unlike an ion. Ionic charges (e.g., a sulfonate or phosphate) are quickly solvated by water molecules, making it quicker for small ionic surfactants to stabilize the interface. Since small ionic surfactants can more quickly adjust to changing environments, in phase inversion they are more effective at slowing demixing/solidification of the polymer. This can be seen in the large network structures from membranes cast with RHODAFAC (FIG. 1).

One object of a desirable support layer casting process is to obtain a support layer with uniform porous surfaces with a large number of macrovoids less than about 1 micron below the surface. In one embodiment, this is achieved by using a casting formulation of 14% polymer (e.g., PS or PES) in solution with DMF, 0.1-3% nonionic surfactant (e.g., BRIJ or another polyethylene oxide attached to an alkyl chain), and 0.1-3% ionic surfactant. The internal structures of all of the experimental membranes formed from this solution are open with many macrovoids, regardless of the casting temperature.

Generally, highly porous surfaces are important as they increase the speed of water transport from the feed water into the draw solution side of the membrane. As shown in FIG. 4, it appears that the temperature of the quench tank greatly affected the surface porosity, unlike the surface of a membrane formed at 18° C. with ionic surfactants (FIG. 2), which might be due, at least in part, to the nonionic surfactants failing to stabilize the DMF/water and polymer interface. With a quench tank at 18° C., the PES demixing is so rapid that the polymer shrinks away from the incoming water and into its solid mass with few, although large, pores. The surface formation at higher temperatures is more porous than at lower temperatures, because the polymer has more energy to stay soluble in the water/DMF environment, which slows the rate of polymer solidification and causes more porosity to form at the surface. The more effective and available a surfactant, the better it is at lowering the energy of the interaction, and the slower the solidification precipitation of the PS. It has been shown that rapid solidification/precipitation during formation of the support layer may result in a top surface containing closely packed granules, which may occur in cases of very little surfactant or too small of a concentration of a large nonionic surfactant (e.g., BRIJ 58) (see FIG. 5A-5C). FIGS. 5A-5C represent the scanned surfaces of membrane supports made with 14% PES in DMF with 1% BRIJ 58 (2,000×) (FIG. 5 A, few granules), 0.8% BRIJ 58 (8,000×) (FIG. 5B, many granules), and 0.5% BRIJ 58 (400×) (FIG. 5C, many granules).

This stabilization lowers interfacial energy, which slows the rate of polymer demixing/solidification, which stops granule formation and creates a porous surface even at colder temperatures (see, e.g., FIG. 2). By using small ionic surfactants in the quench tank, instead of the casting solution, we were able to induce a porous surface without granules, while maintaining an internal structure consisting mostly of macrovoids.

A small amount of ionic surfactants in the quench tank water can act to stabilize the interface at the surface of the membrane during the first seconds of the demixing process. However, as the water penetrates the membrane surface towards the substrate/web, the concentration of ionic surfactants in the water coming in contact with the PES interface would decrease, because the surfactants would be concentrated at the surface of the membrane thereby lowering the interfacial energy at the surface of the membrane. With less ionic surfactant available to stabilize the internal structure formation, the demixing in the membrane will be faster, causing macrovoids to form. At a certain concentration of ionic surfactant in the quench tank (which can be experimentally optimized to suit a particular application), macrovoids will still form below the surface. Surfactant stabilization of the surface formation may help prevent the formation of surface granules by slowing the rate of demixing/solidification. This will also allow for a porous surface at colder temperatures.

More nonionic surfactant was shown to reduce granule formation, but there was too much surfactant left on the membrane/quench tank. Polyethylene glycol, or PEG, is the water soluble component of the nonionic surfactants used in some of the casting solutions disclosed herein. PEG bearing surfactants are likely to present a LCST behavior, so it would be beneficial to have the first quench tank to be at 180° C. rather than 45° C. Casting at colder temperatures has been shown to decrease the surface porosity (see, e.g., FIG. 4). By using ionic surfactants in the quench tank, we are able to cast into a colder quench tank without sacrificing surface porosity.

In various embodiments, we cast PS/PES membrane supports using only 2% BRIJ 020, which produced a support layer with macrovoids and few granules at the surface. However, supports cast with 1% BRIJ 020 had many granules over a substantial portion of the support layer surface. When 2% BRIJ was used in the casting formulation, there was typically surfactant left in the quench tank and on the membrane, which required stopping the casting process so that the quench tank could be emptied and refilled. By adding surfactant(s) to the quench tank, we were able to dissolve the nonionic surfactants quicker resulting in a “cleaner” membrane. The ionic surfactants will help dissolve the nonionic surfactants, making them easy to clean out by blowing down the water.

In some embodiments, the ionic surfactants may impede the phase inversion (by limiting the formation of macrovoids) if used in the quench tank; however, the surfactants could still be added to the subsequent rinsing tanks in order to help wash off the nonionic surfactants from the membrane. A water shower may be used to clean the membrane of both types of surfactants at the end of the casting line. Generally, in an effort to limit granule formation on the membrane support layer surface, ionic surfactants can be used in the quench tank or additional nonionic surfactants could be used in the casting solution while adding ionic surfactants to the subsequent rinse tanks.

The present invention can use additional processes for enhancing the casting process and removing excess surfactants. Generally, the surfactants, due to their size and nonionic nature, are not easily washed away after phase inversion and subsequent rinsing tanks. Washing away surfactant is important, as excess surfactant can linger on the casting machine, thereby spoiling the phase inversion for membrane produced further down on the same roll. Also, left over surfactant has a good chance of negatively influencing active layer formation on the cast support layer. The use of sonication would increase the solubility of the surfactant and other impurities, thereby improving the quality of the membrane. In addition, the use of sonication allows for more freedom when selecting surfactants, as surfactants that would previously not be desirable could now be used, as their ability to be removed will improve.

As previously disclosed, the casting solution is typically sprayed onto a polyester web and passed through a quench tank for phase inversion to take place. The quench tank or subsequent rinsing tanks would be outfitted with a probe sonicator or another sonication technology so that it is effectively a large sonicator. The sonication would be focused where the membrane passes through the tank to increase effectiveness of the sonicator. Sonication makes substances dissolve into the liquid phase quicker. The sonication in the phase inversion bath could plasticize the polysulfone or polyethersulfone, allowing for a more network structure near the surface of the skin layer.

In accordance with one or more embodiments, the finished membrane may include a selective barrier, such as a semipermeable three-dimensional polymer network, comprising, for example, an aliphatic or aromatic polyamide, aromatic polyhydrazide, poly-bensimidazolone, polyepiamine/amide, polyepiamine/urea, polyamide urea, polyethyleneimine/urea, sulfonated polyfurane, polybenzimidazole, polypiperazine isophtalamide, a polyether, a polyether-urea, a polyester, or a polyimide or a copolymer thereof or a mixture of any of them. In certain embodiments, the selective barrier may be an aromatic or non-aromatic polyamide, such as residues of a phthaloyl (e.g., isophthaloyl or terephthaloyl) halide, a trimesoyl halide, or a mixture thereof. In another example, the polyamide may be residues of diaminobenzene, triaminobenzene, polyetherimine, piperazine or poly-piperazine or residues of a trimesoyl halide and residues of a diaminobenzene. The selective barrier may also comprise residues of trimesoyl chloride and m-phenylenediamine. Further, the selective barrier may be the reaction product of trimesoyl chloride and m-phenylenediamine. Generally, the selective barrier may be characterized by a thickness adequate to impart desired salt rejection and water permeability properties while generally minimizing overall membrane thickness. In certain embodiments, the selective barrier may have an average thickness from about 50 nm and about 200 nm. The thickness of the barrier layer is desired to be as limited as possible, but also thick enough to prevent defects in the coating surface. The practice of polyamide membrane formation for pressure driven semipermeable membranes may inform the selection of the appropriate barrier membrane thickness. The selective barrier may be formed on the surface of a porous support via, for example, via interfacial polymerization.

Other polymers that may be suitable for use as porous supports in accordance with one or more embodiments include poly(ether sulfone ketone), poly(ether ethyl ketone), poly(phthalazinone ether sulfone ketone), polyacrylonitrile, polypropylene, poly(vinyl fluoride), polyetherimide, cellulose acetate, cellulose diacetate, and cellulose triacetate polyacrylonitrile.

In particular embodiments, the support layer is a PS or PES based layer including certain additives (e.g., surfactants to enhance pore formation) and excluding other additives that are commonly used in the prior art. Table 1 below lists a number of examples of support layer formulations that may be suitable for different applications, such as improved flux and/or improved solute rejection. Generally, various polymer solutions (e.g., PS or PES) were doped with various surfactant additives to form phase inversion membranes and excluded the use of polyvinylpyrrolidone (PVP) or polyethylene glycol (PEG). Some of the additives that were used included different surfactants like SPAN 80, TWEEN 20 & 80, sodium dodecyl sulfate (SDS), cetyltrimethyl ammonium bromide (CTAB), and TRITON X-100 as pore formers in order to change the membrane morphology. Ideally, the surfactant additive will not remain on the surface of the membrane so that an active layer to be applied thereto. The formulations of the proposed doping solutions are also unique in that they contain different surfactants, a different polymer, a different percentage of polymer, a different percentage of surfactant additives, a different solvent, and no other additives other than the surfactant (e.g., PVP or high molecular weight PEG). These formulas typically included DMF and/or NMP as a solvent and many also included water at, for example, about 0.1 to about 1.0 wt %, preferably about 0.25 to about 0.75 wt %, and more preferably about 0.35 to about 0.45 wt %. Generally, the surfactant additive to the solution assists in developing finger type structure to improve wetting of current forward osmosis membrane support layers. Another goal is to reduce internal concentration polarization and improve flux of the forward osmosis membranes made in accordance with the invention. This has been achieved through the development of finger type structure and a thin skin layer that in turn improves the osmosis efficiency of draw solutions.

TABLE 1

| | | Viscosity | CBT | Avg CWF | Std |
|---|---|---|---|---|---|
| Polymer | Surfactant | (cP) | (° C.) | (gfd) | Dev |
| 15% | 3% TRITON X-305 | 292.8 | 18 | 48.0 | 2.8 |
| | | | 25 | 56.6 | 4.6 |
| | | | 35 | 78.8 | 1.3 |
| 16% | 2% TRITON X-405 | 428.9 | 25 | 51.6 | 6.3 |
| 14% | 4% TRITON X-705 | 234.4 | 25 | 107.6 | 3.3 |
| 14% | 2% TRITON X-305 | 196.5 | 18 | 118.8 | 4.0 |
| 15% | 4% TRITON X-405 | 367.8 | 18 | 87.4 | 4.5 |
| 16% | 3% TRITON X-705 | 311.8 | 18 | 78.2 | 5.1 |
| 16% | 4% TRITON X-305 | 402.6 | 35 | 56.8 | 4.8 |
| 14% | 3% TRITON X-405 | 185.1 | 35 | 128.4 | 9.7 |
| 15% | 2% TRITON X-705 | 242.2 | 35 | 86.6 | 5.0 |
| 15% | 3% TRITON X-305 | 292.8 | 25 | 54.6 | 4.6 |
| 14% | 2% TRITON X-705 | 186 | 18 | 128.2 | 6.8 |
| 14.5% | 2% TRITON X-100 | 198.4 | 35 | 110.0 | 12.0 |
| 14.5% | 3% TRITON X-405 | 226.3 | 35 | 124.0 | 7.7 |
| 15% | 2% TRITON X-405 | 304.0 | 35 | 92.4 | 5.0 |
| 15% | 3% TRITON X-100 | 226.9 | 35 | 98.8 | 8.5 |
| 14.5% | 2% TRITON X-405 | 194.4 | 18 | 115.6 | 5.6 |
| 14.5% | 3% TRITON X-100 | 203.0 | 18 | 107.8 | 2.6 |
| 15% | 2% TRITON X-100 | 209.8 | 18 | 89 | 2.1 |
| 15% | 3% TRITON X-405 | 257.9 | 18 | 92.6 | 2.9 |
| 13.5% | 2% TRITON X-100 | 131.0 | 45 | 162.6 | 8.5 |
| 13.5% | 2% TRITON X-405 | 141.2 | 45 | 175.0 | 7.4 |
| 13.5% | 2% TRITON X-100 | 131.0 | 18 | 151.6 | 5.3 |
| 13.5% | 2% TRITON X-405 | 141.2 | 18 | 126.2 | 6.7 |
| 14% | 2% TRITON X-100 | 154.4 | 18 | 119.8 | 3.8 |
| 14% | 2% TRITON X-100 | 154.4 | 45 | 173.0 | 0.7 |
| 14% | 3% TRITON X-100 | 170.0 | 18 | 124.0 | 7.5 |
| 14% | 3% TRITON X-100 | 170.0 | 45 | 183.4 | 4.0 |
| 13.5% | 2% TRITON X-305 | 139.0 | 18 | 132.6 | 1.3 |
| 13.5% | 2% TRITON X-305 | 139.0 | 45 | 175.8 | 3.6 |
| 13.5% | 2% TRITON X-705 | 141.4 | 18 | 114.0 | 2.4 |
| 13.5% | 2% TRITON X-705 | 141.4 | 45 | 162.2 | 3.8 |
| 13.5% | 2% TRITON X-305 | 145.1 | 45 | 168.2 | 4.0 |
| 14% | 3% TRITON X-100 | 164.4 | 45 | 174.4 | 9.4 |
| 14% | 3% BRIJ C10 | 158.1 | 45 | 168.4 | 8.8 |
| 14% | 3% BRIJ O20 | 163.1 | 18 | 170.6 | 17.0 |
| 14% | 3% BRIJ O20 | 163.1 | 45 | 189.6 | 14.9 |
| 14% | 3% BRIJ L4 | 152.6 | 45 | 156.8 | 21.9 |
| 14% | 2% BRIJ O20 | 153.9 | 45 | 191.4 | 7.6 |
| 14% | 2% BRIJ O20 | 153.9 | 18 | 175.6 | 9.1 |
| 14% | 2% BRIJ L4 | 144.2 | 18 | 91.4 | 5.5 |
| 14% | 2% BRIJ C10 | 151.5 | 18 | 157.2 | 5.3 |
| 14% | 2% BRIJ L4 | 144.2 | 45 | 139.8 | 9.0 |
| 14% | 2% BRIJ C10 | 151.5 | 45 | 186.6 | 11.1 |
| 14% | 2% TERGITOL 15-S-30 | 169.3 | 45 | 191.8 | 6.3 |
| 14% | 2% TERGITOL 15-S-9 | 154.0 | 45 | 185.6 | 5.2 |
| 14% | 3% TERGITOL 15-S-9 | 155.0 | 45 | 188.6 | 6.8 |
| 14% | 2% TERGITOL 15-S-9 | 154.0 | 18 | 151.8 | 5.3 |
| 14% | 3% TERGITOL 15-S-9 | 155.0 | 18 | 170.6 | 6.4 |
| 14% | 2% TERGITOL 15-S-30 | 169.3 | 18 | 155.6 | 11.5 |
| 14% | 2% TERGITOL NP-9 | 152.4 | 18 | 98.8 | 5.6 |
| 14% | 2% TERGITOL NP-9 | 152.4 | 45 | 155.2 | 7.3 |
| 14% | 3% TERGITOL 15-S-5 | 163.7 | 45 | 150.4 | 4.2 |
| 14% | 3% TERGITOL 15-S-5 | 163.7 | 18 | 110.8 | 2.5 |
| 14% | 3% MACKAM LSB 50 | 210.8 | 18 | 119.0 | 3.7 |
| 14% | 3% MACKAM LSB 50 | 210.8 | 45 | 162.2 | 2.3 |
| 14% | 3% PEG 200 | 163.3 | 18 | 83.2 | 6.8 |
| 14% | 3% PEG 200 | 163.3 | 45 | 126.4 | 6.1 |
| 14% | 3% PEG 400 | 163.7 | 18 | 101.6 | 2.2 |
| 14% | 3% PEG 400 | 163.7 | 45 | 146.2 | 7.8 |
| 14% | 3% PEG 600 | 152.3 | 18 | 94.6 | 5.4 |
| 14% | 3% PEG 600 | 152.3 | 45 | 121.0 | 7.3 |
| 14% | 3% PEG 1000 | 160.6 | 18 | 132.0 | 7.7 |
| 14% | 3% PEG 1000 | 160.6 | 45 | 165.4 | 4.8 |
| 14.5% | 0.15% RHODAFAC | 272.3 | 32 | 138.0 | 5.3 |
| | 0.45% BRIJ58 | | | | |
| 14.5% | 0.15% RHODAFAC | 261.4 | 18 | 153.0 | 5.3 |
| | 0.30% BRIJ58 | | | | |

Typical TFC forward osmosis membranes are made mostly from PS, which is a hydrophobic polymer. The hydrophobicity of the PS and the constrained porosity structure of PS support layers of membranes result in poor wetting of draw solution on the back side of membrane. The water flux from the feed side to the draw side reduces the concentration of draw solution near the active layer in contact with the support layer. Also the constrained porosity structure of the support layer and the substrate makes it difficult for the bulk draw solution to reach to the side closest to the active layer and to re-concentrate the draw solution closest to the active layer (which is what determines the osmotic differential driving force). This will result in internal concentration polarization that will reduce the osmotic differential efficiency of the forward osmosis system.

The surfactants that are good candidates as pore formers or additives in solution of PS/PES and DMF will vary to suit a particular application and are typically surfactants that have a low molecular weight and can be easily washed out in casting machine rinse tanks during manufacturing. Also the desirable surfactants are those that upon remaining in small amounts in the support layer, do not impact formation, uniformity and quality of an active layer in the coating process.

Typical membrane support layers were created using a non-solvent (water) phase inversion method and doping solutions consisting of PS or PES, surfactant, and N—N Dimethylformamide (DMF). Surfactants tested with positive results included the following: TRITON (Octylphenol Ethoxylates), such as TRITON X-305, TRITON X-405, TRITON X-705; TERGITOL (Secondary Alcohol Ethoxylates), such as TERGITOL 15-S-5, TERGITOL 15-S-9, TERGITOL 15-S-30; BRIJ (Ethoxylated Fatty Alcohols), such as BRIJ L4, BRIJ CIO, BRIJ 020; BRIJ 58, MACKAM LSB 50 (cocamidopropyl hydroxysultaine); and low molecular weight polyethylene glycol with a molecular weight between 100 to 2000. The initial membranes created were formed using hand casting method solutions were all casted at an 18° C., 45° C. and 60° C. coagulation water bath. The PS/PES concentration can be vary from 10 wt % to 20 wt % with the best results occurring between about 13 wt % to about 15 wt %. The concentration of surfactants can vary from about 0.1 wt % to 8 wt % with best result occurring between about 2 wt % to about 4 wt %. The solution temperature can be varied from about 15° C. to about 45° C. The coagulation bath temperature can be vary from about 12° C. to about 65° C. where higher coagulation bath temperatures will result in higher CWF and higher FO flux.

In some experiments, the membranes were cast on a manufacturing line with 2% surfactant (BRIJ 020, TERGITOL 15-S-9 and TERGITOL 15-S-30) at coagulant bath temperatures of about 18° C. and about 45° C. All membranes cast on the previously described bilayer substrate with the second layer removed after casting, which resulted in an improved clean water flux of about 6-10 times over the more conventional PS supports. After coating an active layer on the new PES support formulation, the flux was improved 40 to 50% upon current PS support layer when 50,000 ppm NaCl solution was used as feed and a 1.8 molar ammonium carbonate solution was used as a draw solution. Wetting with 5% IPA had no impact on performance.

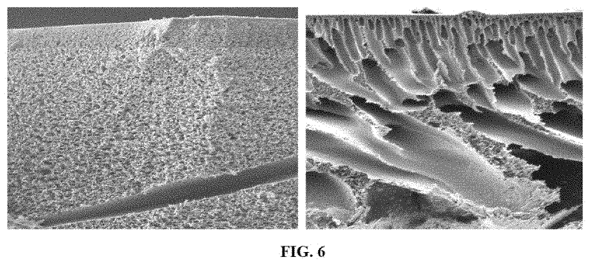

SEM images of the membranes are shown in FIG. 6. The left picture is a current commercial PS structure that has a dense network and the right picture is a new machine cast PS/PES membrane in accordance with the invention with fully developed finger type structures. The formulation includes 2% BRIJ 020 with the coagulation bath temperature at 45° C.

The above described PS/PES membrane manufactured with casting machine was FO tested with a wetting process and without a wetting process. Table 2 below shows there is no difference in TFC FO membrane performance with or without wetting process.

TABLE 2

| | Membrane | 0.5M NaCl vs. 1.5M NaCl | | DI vs. 0.5M NaCl | |
|---|---|---|---|---|---|
| Trial | Cast | Non-wet out | Wet out | Non-wet out | Wet out |
| 2 | PES-5 | 6.18 | 6.38 | 10.2 | 9.8 |

In alternative embodiments, the support layer is PS, PES or a combination of the two in a solution of DMF and 0.01% to 5% surfactants, with or without other additives. Such as water, with or without a salt, such as lithium chloride (LiCl) cast on a substrate, such as a non-woven polyester (or polypropylene) and then immersed in a coagulation/quench bath and rinsed in water. Typically, the support layers disclosed herein will be coated with an aqueous phase first and then an organic phase to produce a selective layer and final membrane for use in forward osmosis.

The aqueous phase may consist of m-Phenylenediamine (MPD), m-xylylenediamine, cyclohexane-1,3,5-triamine, benzene-1,3,5-triamine, 4H-1,2,4-triazole-3,4,5-triamine, piperazine, p-phenylenediamine, 1 wt % to 10 wt % in water and their combination with or without surfactant, such as those disclosed herein. The following additives, either alone or mixtures of them, with an acid (e.g., acetic acid, camphorsulfonic acid, methanesulfonic acid, trifluoroacetic acid, nitric acid, HCl acid, and citric acid), will be added to the aqueous phase to control flux and rejection of the FO membrane and include: Triethylamine, N-Methyldiethylamine, N,N-Dimethylethylamine, Trimethylamine, N,N-Diisopropylmethylamine, N,N,N′,N′-Tetramethyldiaminomethane, N,N,N′,N′-Tetramethylethylenediamine [(diethylamino)methyl]diethylamine, Hexamethylenetetramine, Triethylenediamine, 1,3,5-Triaza-7-phosphaadamantane, Isopropylamino-2-dimethylaminoethane, Tris(2-aminoethyl)amine, Tris(3-aminopropyl)amine, 2,2′Diamino-N-methyldiethyamine, N,N-Diethylethylenediamine, N,N′,N″-Trimethyldiethylenetriamine, N,N-Dimethylethylenediamine, (Dimethylamino)-1-propylamine, N,N-Bis[3-(methylamino)propyl]methylamine, N′-(2-aminoethyl)-N-methylethane-1,2-diamine, dimethylamine, Ethylmethylamine, Diethylamine, Ethylenediamine, 1,4-Diaminobutane, N-Methylethanediamine, N,N′-Dimethylethylenediamine, N-Ethylisopropylamine, N-Isopropyl-N-propylamine, Bis[2-(methylazaniumyl)ethyl]azanium, N,N′-Bis(3-aminopropyl)-1,3-propanediamine, Bis(3-aminopropyl)amine, Tetraethylenepentamine, Ethanolamine, 2-[2-aminoethyl(2-hydroxyethyl)amino]ethanol, N-(3-Aminopropyl)diethanolamine, Triethanolaminedimethylaminoethanol, triethanolamine (e.g., 4%), N-Methyldiethanolamine, N-Ethyldiethanolamine, N-Butyldiethanolamine, Diethanolamine, 2-[2-(Dimethylamino)ethoxy]ethanol, N-Phenyldiethanolamine, Nitrilotriacetic Acid, Bis(2-chloroethyl)methylamine Hydrochloride, 1,4-diaZabicyclo[2,2,2], N,N,N′,N′-tetramethyl-1,3-butanediamine (TMBD), N,N,N′,N,N,N′,N′-Tetramethyl-1,6-hexanediamine, N,N,N′,N″,N″-Pentamethyldi ethylenetriamine. Additional additives include: quaternary ammonium cations compounds and there surfactants, such as Cocamidopropyl betaine (CAPB) and dodecyl methyl poly (ethylene oxide) ammonium chloride; amine oxide surfactants, such as lauryldimethlyamine oxide, N,N-dimethyldodecylamine N-oxide, N,N-dimethyltetradecylamine N-oxide, and 3-Dodecylamido-N,N′dimethylpropyl amine oxide (LAPAO); and organophosphorus compounds, such as Tetrakis(hydroxymethyl)phosphonium chloride and Bis[tetrakis(hydroxymethyl)phosphonium] sulfate solution.

The organic phase may include of trimesoyl chloride (TMC) (0.1 wt % to 0.3 wt %) in isopar G or cyclohexane, with or without Mesitylene co-solvent. Other monomers can be use with or without TMC, such as isophthaloyl chloride, 1,3,5-cyclohexanetricarbonyl chloride, 1,2-cyclohexanedicarbonyl dichloride, trans-1,4-cyclohexanedicarbonyl chloride, benzene-1,3,5-triisocyanate, and 1,3-Phenylene diisocyanate.

Generally, the above additive(s) and surfactant(s) will add to the crosslink network that forms due to the reaction between the MPD and the TMC. Some of the additives react with the TMC and form covalent bonds and some others form hydrogen bonds and ionic bonds within the active layer. Other additive(s) and surfactant(s) form ionic bonds with carboxylic acid or form hydrogen bonds with the aromatic polyamide. The presence of these additive(s) and surfactant(s) change wettability of the support layer, and due to the physical bond formation in the pores of the active layer, reduce flux in RO tests, while improving the rejection of the active layer in FO tests.

Generally, forming efficient and functional support layers for FO membranes is very difficult. Contrary to previous reports, finger-like microstructures formed by dissolving a PS in a pure solvent or mixture of solvents is not ideal. While finger-like microstructures might improve the S parameter of the membrane and decrease losses in the osmotic potential of the draw solution, the robustness of this microstructure to withstand hydraulic pressure is questionable. Although not typical in an FO process, higher hydraulic pressures (e.g., about 100 to 250 psi, which is substantially less than typical RO pressures) sometimes arise and the collapse of an active layer disposed thereon have been observed, specifically for PES based supports with large finger-like macrovoids. Accordingly, it has been found that support casting formulations that generate microstructures that are a combination of finger-like and network architectures with enough network structure under the skin layer to support the active layer when submitted to high hydraulic pressures (e.g., 100-250 psi) and more fingerlike microstructures further from the skin layer allow the draw solution to better penetrate the support and reach the active layer with fewer obstacles than in an entirely network architecture provide improved FO membrane performance. Using the various support layer casting formulations described herein alter the casting solution dynamics during phase inversion such that the support layer has a more open internal structure. These modified support layers allow for improved FO performance while also withstanding higher than normal hydraulic pressures without resorting to the thicker, denser support layers found in RO membranes that are so detrimental to FO performance.

In various embodiments, the casting solution includes a polysulfone in combination with a nonionic surfactant (e.g., a poly oxy ethylene (20) cetyl ether, such as BRIJ 58) and an anionic surfactant (e.g., polyoxyethylene nonyl phenyl ether phosphate, such as RHODAFAC RE610), along with water and DMF. In some embodiments, the casting solution includes one or more of the following: polysulfone in a concentration of about 10% to 17%, preferably about 12% to 15%, and more preferably about 13.5% to 14.5%; an anionic surfactant (e.g. RHODAFAC or similar) in a concentration of about 0.01% to 1.0%, preferably about 0.05% to 0.50%, and more preferably about 0.08% to 0.15%; a nonionic surfactant (e.g., BRIJ 58 or similar, such as those disclosed herein) in a concentration of about 0.01% to 2.0%, preferably about 0.05% to 1.5%, and more preferably about 0.08% to 1.0%; and water in a concentration of about 0.01% to 2.0%, preferably about 0.05% to 1.5%, and more preferably about 0.08% to 1.0%; all in a DMF solution prepared at about 10° C. to 50° C., preferably about 15° C. to 40° C., and more preferably about 20° C. to 35° C., with a coagulation bath (e.g., quench tank) temperature of about 5° C. to 70° C., preferably about 10° C. to 60° C., and more preferably about 12° C. to 50° C. In some embodiments, the nonionic surfactant can be one or more nonionic surfactants in combination and can be composed of a hydrophobic part, such as an alkyl chain, and/or a hydrophilic part, such as a PEG chain. In some embodiments, the casting solution is polysulfone in combination with one or more nonionic surfactants in a DMF solution, with the nonionic surfactant providing a more open internal structure. In various examples, the casting solutions described above resulted in membrane support layers having surface pores in the range of about 10-110 nm, clean water flux of about 80-210 GFD, and thicknesses of about 33-70 μm.

In accordance with one or more embodiments, the support layer may be characterized by a thickness adequate to provide support and structural stability to a membrane during manufacture and use while generally minimizing overall membrane thickness. In certain embodiments, the polymer support may have an average thickness from about 10 μm and to about 75 μm. It is generally desirable for the support to be as thin as possible without compromising the quality of the support surface for interfacial polymerization of the barrier layer. The smoother the support layer is, the less thickness of support material is generally required for this criterion. In at least some embodiments, this layer is less than approximately 40 μm. In certain embodiments, the porous support has a first side (active side) with a first plurality of pores, and a second side (support side) with a second plurality of pores. In certain embodiments, the first plurality of pores and the second plurality of pores are fluidly connected to each other. In one embodiment, polymeric additives are dispersed within the porous support. Additives may enhance hydrophilicity, fouling resistance, strength or other desirable properties, for example, about 0.1-1% of PVP may be added to the PS to enhance hydrophilicity in the structure.

In accordance with one or more embodiments, a thin-film composite membrane may include a porous support comprising a first side with a first plurality of pores, and a second side with a second plurality of pores, wherein the average diameter of substantially all of the first plurality of pores is between about 50 nm and about 500 nm, and the average diameter of substantially all of the second plurality of pores is between about 5 μm and about 50 μm. The purpose of the top layer is to allow for a high quality barrier to form by interfacial polymerization or other deposition method, and to provide mechanical support to a very thin barrier layer. The purpose of the remainder of the support structure is to be as open and as minimally tortuous as possible, while being as thin as possible. Large pores towards the bottom may facilitate this purpose.

In certain embodiments, the membrane flux may be between about 15 and about 25 gallons per square foot per day under operating conditions of 1.5 M NaCl draw solution and a DI feed solution at 25° C. This high flux is an indication of the effectiveness of the thin, open, porous, and low tortuosity support layer in reducing resistance to diffusion of draw solutes into the membrane support structure to provide driving force for flux in the form of osmotic pressure. This high flux is due in part also to the water permeability of the barrier layer.

In accordance with one or more embodiments, a forward osmosis membrane may be formed by first creating a support layer. In some embodiments, a thin fabric backing layer of less than about 30 micrometers may be coated with a PS solution of about 12.5% in dimethylformamide. Lower concentrations of PS may be used to further improve forward osmosis membrane properties, including flux. In some embodiments, the amount of polysulfone coating may generally be less than about 16 g/m² to minimize the impact of the support layer on diffusion. The application of a support layer on a typical reverse osmosis fabric backing of about 3.9 mils in thickness may result in much less than optimal forward osmosis flux.

The resulting support layer precursor may then be immersed in room temperature water causing the phase inversion of the polymer. Immersion in temperatures greater than 90° F. may be used to improve the pore size characteristics of the support layer. This may produce a thin, microporous, open support structure with an embedded web giving the polymer strength for rolling and handling. The active layer may then be applied to the support structure. An example of the coating of this support structure with the active layer would be the immersion of the support in a solution containing polyamide or other desired active material. In one embodiment, the support structure may be immersed in a 3.4% solution of 1-3 phenylenediamine in room temperature water. The concentration of the solution may vary based on desired characteristics of the applied active layer. Duration of immersion may also vary. In some embodiments, the duration may be less than about 5 minutes. In one specific embodiment, the duration of immersion may be about 2 minutes. Excess solution from the surface of the membrane may be removed, for example with a roller or air knife.

The membrane may then be briefly immersed in another solution to induce the polymerization of the poly amide rejecting layer by combination of the diamine in the aqueous phase and, for example, acid chloride in the non-aqueous phase, at the surface of the support material where the phases meet. In some embodiments, the membrane may be immersed in the solution for about 2 minutes. In one embodiment, a 0.15% solution of 98% 1,3,5 benzenetricarbonyltrichloride in Isopar® C or G at room temperature may be used. The membrane may then be removed and the Isopar® allowed to evaporate from the membrane for a period of time, for example less than about 5 minutes. In some embodiments, the duration of the evaporation step may be about 2 minutes. In some embodiments, immersion may take the form of a dip coating process, such as one in which substantially only the surface of the membrane comes into contact with a solution. In other embodiments, the entire membrane may be submerged in the bath. In some embodiments, a combination of these techniques may be used, such as in a sequence of different immersion steps.

In accordance with one or more embodiments, various techniques disclosed herein may be used to make membranes for forward osmosis applications. In accordance with one or more embodiments, various techniques disclosed herein may also be used to make membranes for applications involving pressure retarded osmosis. In some embodiments, pressure retarded osmosis may generally relate to deriving osmotic power or salinity gradient energy from a salt concentration difference between two solutions, such as a concentrated draw solution and a dilute working fluid. Within pressure retarded osmosis, a draw solution may be introduced into a pressure chamber on a first side of a membrane. In some embodiments, at least a portion of the draw solution may be pressurized based on an osmotic pressure difference between the draw solution and a dilute working fluid. The dilute working fluid may be introduced on a second side of the membrane. The dilute working fluid may generally move across the membrane via osmosis, thus increasing the volume on the pressurized draw solution side of the membrane. As the pressure is compensated, a turbine may be spun to generate electricity. A resulting dilute draw solution may then be processed, such as separated, for reuse. In some embodiments, a lower-temperature heat source, such as industrial waste heat may be used in or facilitate a pressure retarded osmosis system or process.

Having now described some illustrative embodiments, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

1. A forward osmosis membrane comprising:
a support substrate having a first surface and an opposing second surface;
a support layer disposed on the first surface of the support substrate, the support layer comprising a polymer, an ionic surfactant, and a nonionic surfactant; and
a selective layer disposed on the support layer.

2. The forward osmosis membrane of claim 1, wherein the support layer polymer comprises at least one of a polysulfone or a polyethersulfone.

3. The forward osmosis membrane of claim 1, wherein the support layer nonionic surfactant comprises polyoxyethylene (20) cetyl ether.

4. The forward osmosis membrane of claim 1, wherein the support layer nonionic surfactant comprises an organic acid phosphate.

5. A support layer for a forward osmosis membrane comprising:
a polymer comprising at least one of polysulfone or polyethersulfone;
an ionic surfactant; and
a nonionic surfactant.

6. The support layer of claim 5, wherein the nonionic surfactant comprises polyoxyethylene (20) cetyl ether.

7. The support layer of claim 5, wherein the ionic surfactant comprises an organic acid phosphate.

8. A method of making a support layer for a forward osmosis membrane, the method comprising the steps of:
providing a support substrate having a first surface and an opposing second surface;
casting a polymer solution onto the first surface of the substrate, wherein the polymer solution comprises a polymer comprising at least one of polysulfone or polyethersulfone, a nonionic surfactant, an ionic surfactant, and a solvent;
introducing the support substrate to a quench bath.

9. The method of claim 8, wherein the quench bath comprises a solution at about 18° C. to about 60° C.

10. The method of claim 8, wherein the polymer solution comprises the polymer at about 10 to 20 wt % of the solution.

11. The method of claim 8, wherein the polymer solution comprises the polymer at about 13 to 15 wt % of the solution.

12. The method of claim 8, wherein the polymer solution comprises the ionic surfactant at about 0.05 to 1.5 wt % of the solution.

13. The method of claim 8, wherein the polymer solution comprises the ionic surfactant at about 0.15 to about 0.5 wt % of the solution.

14. The method of claim 8, wherein the polymer solution comprises the nonionic surfactant at about 0.1 to 1.5 wt % of the solution.

15. The method of claim 8, wherein the polymer solution comprises the nonionic surfactant at about 0.3 to 0.75 wt % of the solution.

16. The method of claim 8, wherein the polymer solution further comprises water.

17. The method of claim 8, wherein the ionic surfactant comprises an organic acid phosphate.

18. The method of claim 8, wherein the nonionic surfactant comprises polyoxyethylene (20) cetyl ether.
